(19) United States
(12) Patent Application Publication
(10) Pub. No.: US 2007/0256778 A1
(43) Pub. Date: Nov. 8, 2007

(54) Process of UV serigraphy for manufacturing FRP signs and resulting signs

(76) Inventor: Luciano Fusco, Sao Paulo (BR)

Correspondence Address: CANTOR COLBURN, LLP, 55 GRIFFIN ROAD SOUTH, BLOOMFIELD, CT, 06002, US

(21) Appl. No.: 11/725,409

(22) Filed: Mar. 19, 2007

(30) Foreign Application Priority Data
May 3, 2006 (BR) PI 0601480-1

(51) Int. Cl. B44B 5/02

(52) U.S. Cl. 156/230; 156/386

(57) ABSTRACT

Process of UV serigraphy for manufacturing FRP signs. The process involves using at least one serigraphic device to apply at least one unsaturated polyester resin ink onto at least one side of a partially cured fiber reinforced unsaturated polyester resin laminate in order to form a design thereon and curing the laminate and the at least one ink in two steps, by first partially curing them using at least one UV curing station until the exposed surface of the at least one ink forms a skin that allows it to be handled, while leaving an inner, unexposed portion of the ink that is in contact with the laminate sufficiently sticky and humid so as to allow sufficient time for the ink to chemically crosslink with the laminate during said second curing step; and subsequently allowing the laminate and the at least one ink to fully cure in an area removed from the at least one UV curing station, the subsequent curing step allowing cross-linking to occur between the resin of the laminate and the resin of the at least one ink, thereby fusing the laminate and the at least one ink to form a unitary body. Furthermore, the invention concerns a silk-screened pane made by the above process.

### FIELD OF THE INVENTION

The present invention relates to a process for manufacturing FRP (glass fiber reinforced polyester) signs created by silk-screening images and/or text on one or both sides of a partially cured FRP laminate with inks made of pigmented unsaturated polyester resins, thereby providing unique characteristics of adhesion, mechanical strength and weathering resistance.

These products are used in visual communication, especially for outdoor applications including backlights.

### PRIOR ART

The manufacturing of decorative panels was disclosed by the American patent U.S. Pat. No. 6,627,022, the European document EP 03704113.4 and the Brazilian patents PI 9300068-5, PI 9403679-9, PI 9802274-1 and PI 0201285-5, all in the name of Fusco, wherein the decoration is made by printing paper or plastic films and layers of FRP are, afterward, laminated on one or both sides of the printed substratum. These prior art methods of manufacturing decorative panels have higher production cost and higher production cycle time, in addition to not using inks made of unsaturated polyester resins and, therefore, not reaching the perfect chemical fusion between inks and the FRP laminate as in the present development.

As known by the experts on the matter, painting of plastics substrates is a difficult operation that demands special precautions. Solvents sensitiveness (i.e. the ability of the solvent of the ink to chemically attack the FRP laminate of the panel), heat resistance, and the variety of surface polarity levels are factors that affect the painting of polymeric substrates and the selection of the appropriate system must take into consideration some other factors such as:
the surface polarity which, as known in the art, when low or null, demands a preliminary surfacing treatment which may include, but is not limited to, etching, corona, plasma treatment, or flame treatment;
the necessity that the solvent used must attack the substrate only superficially to achieve the adhesion of the ink, because the extension of the attack can seriously compromise the substrate's mechanical properties, mainly the impact resistance;
the fact that most polymers contain additives (e.g. antioxidant, UV stabilizers, fillers, and minerals) which can migrate to the surface, greatly impeding the ability of ink to adhere thereto, making selection of polymers that don't need such additives desirable;
the ability to withstand environmental conditions in that the final product could be exposed to harsh environmental conditions; and
the mechanical efforts to which the panel may be exposed, such as impacts, scratches, bending of the panel to conform to a particular design, vibrations in the event the panels are applied to trucks, alternating wavering caused by the wind when used in outdoor applications, to name a few.

The most common problems are: stains, cracking, bubbliness, whitening, star cracking, craters, a bumpy surface abnormality known as orange peel, and low adhesion of the ink to the plastic substrate to which it is applied.

The adhesion of conventional UV serigraphic inks known in the art on laminates made of FRP has always been a difficult problem that has yielded questionable results, mainly because such inks do not stand up when exposed to scratches, impacts and aggressions resulting from the exposure to the weather.

The results are even poorer when, as a requirement of production on a large and industrial scale, the inks must be cured by UV radiation.

It seemed obvious that the ideal solution would be the utilization of serigraphic ink made with the same unsaturated polyester resin from which the FRP laminate is composed, inasmuch as this solution would create a panel where ink and laminate melt into each other in a unitary, homogeneous body with no distinction of layers, with low cost and high strength.

Many attempts had been made to achieve this idea, but all were unsuccessful because of the problems found in the process when trying to put this idea into practice.

One of these problems was that the addition of catalysts and accelerators to the unsaturated polyester resins of the inks can cause them to prematurely gel in the silk-screen devices, inasmuch as an industrial-scale serigraphy process requires a pot life of the inks of approximately 3 to 5 hours.

Another problem was that the unsaturated polyester resin, when spread into very thin layers by silk-screening, presents critical conditions and dries prematurely on the screens due to the great exposure of its mass (because of the surface/volume ratio) to environmental light and heat, making a large-scale serigraphic process impossible.

Yet another problem was that the conventional UV curing of inks made of unsaturated polyester resin polymerizes them instantly, not giving them time to chemically attack the substrate so as to crosslink with it, which cross-linking is desirable because joining of two polymer chains by cross-linking increases the strength of the polymer network.

### OBJECT OF THE INVENTION

It is an object of the invention to solve these problems through a simplified UV serigraphic process and which allows obtaining products having high mechanical and weathering strength, durability, low cost, feasibility of use in large scale production, good visual quality, and which is capable of supplying new alternatives to the market.

### SUMMARY OF THE INVENTION

To achieve the above mentioned object, the process according to the present invention was developed, which involves aiming serigraphic printing on perfectly flat and just partially cured FRP laminates using a suitable formulation of inks made of unsaturated polyester resins and curing them with a mixed curing system so as to allow silk-screening directly on one or both sides of the laminates, in such a way as to obtain a chemical cross-linking fusion between inks and laminate, in large industrial scale production.

The cost of the product is low, since inks made of photocurable unsaturated polyester resin are significantly less expensive than conventional UV inks—approximately 70% less.

The cost is further reduced because of the ease of producing neutral (with no decoration) laminates, independent from the decoration, thereby minimizing production losses.

Also, the pre-printing operations (negatives, silk-screens, proofs etc), are made at the same time of the laminates, thereby speeding up the production.

At the same time, the mixed curing system speeds up the drying of the inks, making possible the production on a large industrial scale, which is another object of the invention.

The mixed curing system developed in the present process combines the action of UV curing with the action of chemical-thermal curing, comprising a first step of partially curing the inks by UV radiation on the production line, to a point that allows the handling and the storage and piling up of the panels, followed by a second step of chemical-thermal curing by means of retarded chemical curing agents that have been added to the ink and which stay inactive during the printing phase but start reacting once off the production line, while the panels are piled up and stored.

These chemical-thermal curing agents complete the polymerization of the previously partially cured inks and laminate, the completion of the polymerization taking place off the production line, slowly at room temperature (15-25° C.) or boosted by heated compartments.

In the process according to the present invention, the inks are made with the same resin used in the FRP laminate, properly adjusted to the silk-screening process with regard to their viscosity and their drying time in the silk-screening devices.

The viscosity of the ink can be adjusted by adding thixotropic agents, such as amorphous synthetic silica or silica anhydrous acid to increase viscosity, or by adding solvent to decrease it. Meanwhile, the drying time in the silk-screens can be adjusted by properly equating the relative dosage of catalysts, accelerators and inhibitors or drying retarder agents.

It was verified that inks made of unsaturated polyester resin cured by UV radiation only, though sufficiently dry on their surface so as to allow their handling, can be just pasty inside the layer, in contact with the substrate of FRP, which induce the chemical attack of the inks on the substrate and the consequent fusion by cross-linking, between the inks and the FRP substrate.

For this reason, the UV partial curing is complemented with the chemical-thermal curing through the action of catalysts preferably peroxides of free radicals, and of accelerators, preferably of cobalt.

As known, solutions of unsaturated polyester in monomers are potentially reactive, in that the heat, the light, the pollution and other factors can provoke that a mechanism based on the action of free radicals to start a cross-linking reaction, quickly leading to formation of a gel structure.

Adding to the mass of the ink mixture an adequate system of chemical inhibitors capable of promptly reacting with the free radicals, preventing them from reacting with other double bonds, can prevent the premature gelling or drying of the ink mixture, allowing for a long shelf life, in normal conditions.

In addition to giving storage stability (shelf-life) to the resins, the chemical inhibitors can control the pot-life and the gel-time by their addition to the inks together with curing agents, that is, the photoinitiators, the catalysts and the accelerators.

This problem was satisfactorily solved by balancing the relative amounts of the polymerization agents with inhibitor systems, or drying-retarder agents.

Some inhibitor systems are sensitive to heat and light and react with the free radicals of the unsaturated polyester resin of the ink at room temperature and room light, retarding the polymerization during the silk-screening phase, whereas they decompose at higher temperature and at UV radiation, becoming ineffective as inhibitors and allowing the start of the chemical-thermal curing after passing the UV radiation and being taken off the production line, when the unsaturated polyester inks reach their complete polymerization together with the structural FRP laminate. An example of this kind of inhibitor, or drying-retarder is tert-butyl-catechol.

To retard the polymerization and drying of the unsaturated polyester resin an inhibitor and drying retarder mechanism such as butyl-glycol, in its forms of butyl-diglycol-ether or butyl-triglycol-ether, can also be utilized. When added to the ink, these chemicals serve, not only as inhibitors and drying retarders, but also as solvents. Butyl-glycol is effective for these purposes, but butyl-diglycol-ether is more effective, and butyl-triglycol-ether is even more effective.

Therefore, in one embodiment, the silk-screened panel resulting from the invention comprises a transparent FRP laminate forming the panel's front side allowing impact and scratching resistance, the panel being silk-screened only on its back side with inks made of unsaturated polyester resins, yielding a one-faced panel.

Alternatively, in the case of silk-screening only the back side of a transparent FRP laminate to provide a one-faced panel, a transparent, heat-sealable PET film can be permanently incorporated onto the outer surface of the front side of such FRP transparent laminate, providing a finishing surface free of porosity and washable with most solvents. This PET film comprises DUPONT-MELINEX® 301H and 342 or TERPHANE® 10/93 and 10/21 films.

In another embodiment, the panel can be silk-screened on both sides to produce a double-faced panel, so that the decoration can be made on the front side and on the back side of an opaque FRP laminate. This embodiment would not include a PET film on either surface.

Optionally, the side(s) of the panel having ink layer(s) can be finished with one or more final layers of unsaturated polyester resin, fiber reinforced or not, acting as extra protection against scratches and impacts.

The process will be clearly understood from the following description, which contains the same numeric references used in the figures and the diagrams below contains the same numeric references used in the figures and diagrams below.

### BRIEF DESCRIPTION OF THE DRAWINGS

FIG. 1 is a schematic view of the production line in an embodiment having a continuous conveyer belt.

FIG. 1a is a cross-section of a detail of the UV curing platform in the continuous laminating machine for producing the FRP laminate.

FIG. 2 is a diagram of the typical polymerization of the inks after exposure to UV radiation only.

FIG. 3 is a diagram of the typical evolution of the polymerization of the unsaturated polyester inks under the action of the chemical-thermal curing agents only.

FIG. 4 illustrates a cross-section of the panel after partial UV curing.

FIG. 5 shows the same cross-section of the panel illustrated in FIG. 4 after reaching full polymerization.

### DETAILED EXPLANATION OF THE DRAWINGS

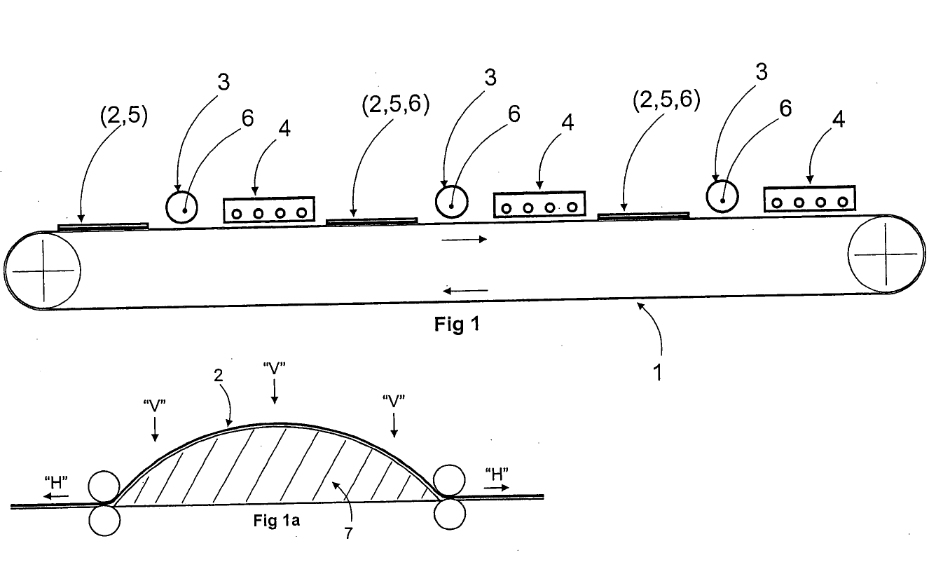

FIG. 1 is a schematic view of the production line, in an embodiment having a continuous conveyor belt (1) which conveys the laminates (2) incorporating finish PET film (5) on its outer side, being silk-screened by serigraphic devices (3) of dispensing the inks (6) and through UV curing stations (4).

As an option, instead of having a central and shared continuous belt, the silk-screening can be made by separated, or independent, silk-screening machines, one for each color; each silk-screening machine provided with its own UV curing set, so that the production is decentralized, each silk-screening machine-UV curing group producing a different kind of panel.

A detail of the continuous laminating machine for producing the laminate (2) in the UV curing phase, with the platform having cylindrical form, is shown in FIG. 1a. This configuration reveals how two horizontal forces “H”, equal and opposed, caused by the haulage of the laminate, applied at the ends of the continuous laminating line, create a vertical reaction force “V” compressing the laminate against the cylindrical base (7) which acts as a mold, assuring the perfect flatness and smoothness of the laminate (2).

In each embodiment of the invention, the finished panel of the invention is a structural panel. As used herein, the term structural means that the panel is free-standing and self-supporting. It does not rely on attachment to or support by anything else for its shape or stiffness. It is capable of standing on its own for use as a sign or as a wall in a cubicle or a bus shelter, for example.

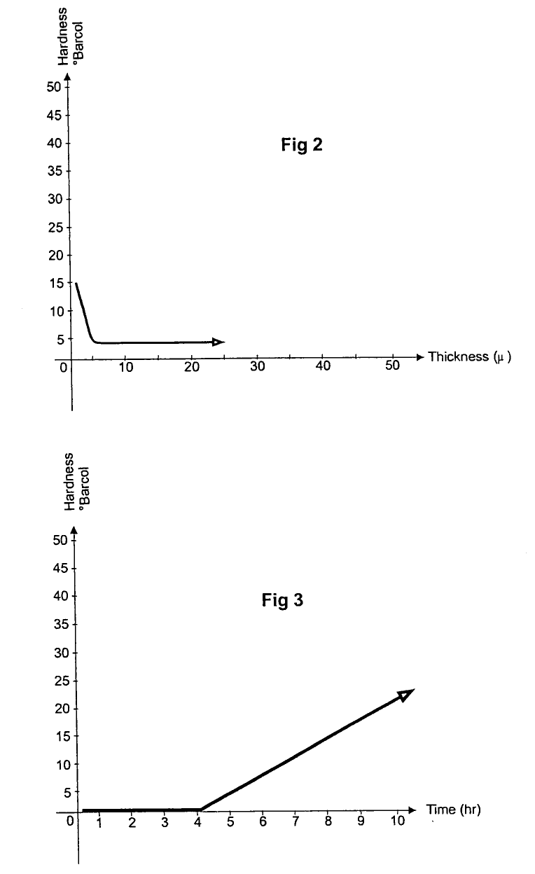

A diagram of the typical polymerization of the inks after exposure to UV radiation only is shown in FIG. 2. The outer surface of the inks is indicated as a depth of 0 (zero) microns. It can be seen from the diagram that after UV radiation, the outer surface reaches drying conditions which allows handling of the panels (around 15-20 Barcol degrees). This is caused by the action of the surface photoinitiators. The diagram also shows that the polymerization decreases with increasing depth within the ink layer, being pasty or sticky or humid in the lower part of the ink layer that is in contact with the substrate.

The diagram of FIG. 3 shows how the typical evolution of the polymerization of the unsaturated polyester inks under the action of the chemical-thermal curing agents only would be. For a few hours there is no reaction, allowing the serigraphic printing process to occur with no interference and no drying in the silk-screening devices. Then the action of the chemical-thermal curing agents starts and polymerization can reach the full cure (around 50 Barcol degrees) when the printed panel is stored off the production line, with polymerization occurring slowly at room temperature or boosted by a heated room.

The real polymerization of the inks in the process of the present invention results from a composite of the diagrams of FIG. 2 and FIG. 3.

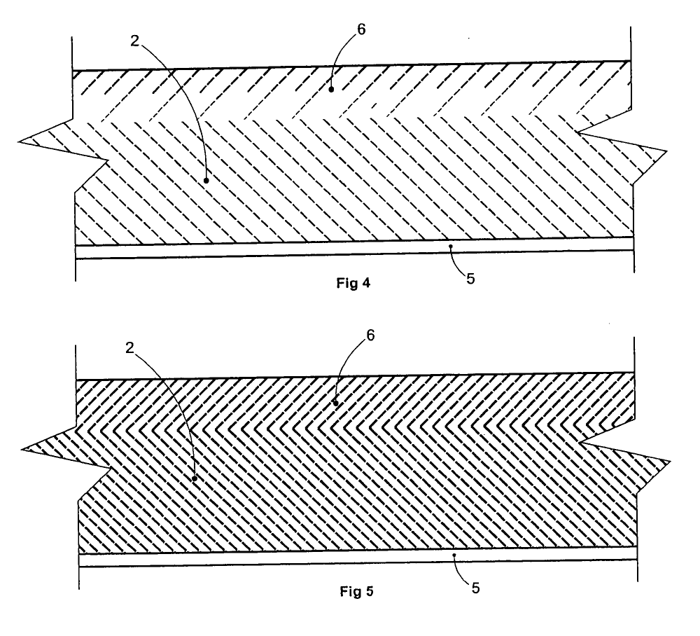

FIG. 4 illustrates a cross-section of the panel after partial UV curing, showing schematically the variation of the polymerization along the thickness of inks layer (6), evidencing that the outer surface of the ink layer is sufficiently cured (around 15 Barcol degrees) to allow the handling of the panel, while the portion of the ink in contact with the laminate (2) is just pasty so as to allow the styrene (which is the chemical used as the solvent in unsaturated polyester resin inks) of the ink to have sufficient time—usually 10 minutes or more—for the chemical attack of the substrate. The FRP laminate is also partially cured at around 15-20 Barcol degrees. The thickness and density of the lines in the cross-sectional view graphically represents the amount of polymerization of the resin of the ink and the resin of the laminate at one particular moment in time during the hardening process. How long this process takes depends upon the curing conditions, and it can take days or even weeks to complete. The outer side of the laminate (2), in this embodiment, can incorporate a finishing PET film (5).

FIG. 5 shows the same cross-section of the panel illustrated in FIG. 4 after reaching full polymerization (around 50 Barcol degrees) by the action of chemical-thermal curing agents, and suggests the crosslinking chemical fusion between inks and laminate. The bigger density of the lines in the cross-section graphically represents the full polymerization grade of the resin of the ink and the resin of the laminate.

### DETAILED DESCRIPTION OF THE MANUFACTURING PROCESS

The FRP laminate can be produced by a continuous lamination process wherein a glass fiber reinforced polyester resin is formed between two PET films, consolidated by its passing through a set of cylinders, UV cured and cut in final sizes. One of the two PET films used in the lamination process can be heat-sealable and permanently incorporated to the laminate, the other being releasing.

The laminating process must assure the perfect flatness of the surface that is going to be silk-screened, free of waves, bubbles or other deformations, in accordance with the procedure shown in FIG. 1a, and it must be only partially cured. Assuming that the polymerization of a polyester resin is measured in the practice by its superficial hardness, and that the full curing hardness is reached at around 50 Barcol degrees and the sufficient working hardness is reached at around 30-35 Barcol degrees, the laminate must be cured just to allow its handling which occurs at around 15-20 Barcol degrees.

Taking advantage of the inhibitory action of oxygen to preserve the partial cure of the unsaturated polyester resin of the laminate, so as to optimize the adhesion by cross-linking with the inks, the PET film on the side to be silk-screened can be removed soon after the laminate is retired from the laminating machine.

The laminate is then silk-screened and partially cured so as to allow the handling and storage of the panels.

The cure of the inks can be preferably made by UV-A radiation using groups of lamps commonly used in reprography, for instance, PHILIPS® TL 60 W/10-R SLV, having low voltage (102 V), low current (0.7 A), low technical power (62 W) and UV Radiation 100 hr (IEC—International Electrotechnical Commission—15.8 W) with convenient useful life (1000 hr). This kind of radiation, acting slower than UV-C, allows a better control of the partial curing, assuring the reaction of cross-ling between the layers of ink and the laminate. Also, the use of UV-A is cheaper and more environmentally friendly than UV-C.

The inks can also be cured by UV-C radiation, conveniently adjusting the exposition time and the distance between the lamps and the laminate. In this case, the lamps are mercury lamps, preferably metal-halide lamps from HERAEAUS AMBA Ltd. (UK), which applies to any mercury UV lamp with the addition of gallium iodide or iron iodide.

The photoinitiators preferably used in the inks are a combination of CIBA® Irgacure® 184 to ensure the correct level of surface cure and CIBA® Irgacure® 819 for through curing. Blends of Irgacure® 819 together with shorter wavelength absorbing photoinitiators such as Irgacure® 184, Darocur® 1173, Irgacure® 907 or Irgacure® 500, can achieve a balance of through and surface cure, as needed. Also, blends comprising highly effective surface curing photoinitiators such as Irgacure® 184 together with the through curing photoinitiators Irgacure® 819 or Irgacure® 369 often deliver the optimum in cure performance, especially for thick and pigmented formulations.

The curing of each ink layer is made in a way to obtain a polymerization of around 15-20 Barcol degrees on the top surface of the ink layer, forming a skin that allows its handling, but leaving the bottom or the inside part of the layer still pasty or humid or sticky, so as to give time to the styrene of the ink to chemically attack and crosslink with the substrate—usually 10-20 minutes or more—be it either the laminate or other previously applied ink layer, allowing the cross-linking.

The inks will achieve their working hardness of approximately 35-40 Barcol degrees, together with the FRP laminate, also partially cured, by the action of the chemical curing agents, that is, catalysts and accelerators, while the panels are piled during their storage in approximately 24 hours, at normal room temperature conditions.

In one example, the surface photoinitiator is a blend of CIBA Irgacure® 184 at 4% and 907 at 1%, the through photoinitiator is a blend of CIBA Irgacure® 819 at 0.2% and 369 at 0.1%, the catalyst is MEKP (methyl ethyl ketone peroxide) at 0.5%, the accelerator is Cobalt Naphtenate or Cobalt Octoate at 0.5%, and the inhibitor is Tert-Butyl-Catechol at 0.3%, all quantities being expressed in weight percent.

The butyl glycol in its forms as butyl-diglycol-ether or butyl-triglycol-ether, with high molecular weight, besides serving as a low rate evaporation solvent, has excellent drying-retarder properties on the unsaturated polyester resin of the ink, and very good results have been obtained replacing the catechol inhibitors by these drying-retarder agents if, at the same time, the amount of the cobalt accelerator is reduced and the catalyst is increased.

So, in another example, the surface photoinitiator is a blend of CIBA Irgacure® 184 at 4% and 907 at 1%, the through photoinitiator is a blend of CIBA Irgacure® 819 at 0.2% and 369 at 0.1%, the catalyst is MEKP (methyl ethyl ketone peroxide) at 1%, the accelerator is Cobalt Naphtenate or Cobalt Octoate at 0.1-0.2%, and the drying-retarder is butyl-diglycol-ether or butyl-triglycol-ether at 4-6%, all quantities being expressed in weight percent.

What is claimed is:

1. A process of using serigraphy to decorate a panel, characterized in that the process comprises the steps of:
providing at least one partially cured laminate made of fiber reinforced unsaturated polyester resins (FRP);
providing at least one ink comprising unsaturated polyester resin;
using at least one serigraphic device to apply said at least one ink onto at least one side of said at least one laminate to form a design which includes one or more of the group consisting of text and images;
curing said at least one laminate and said at least one ink in two steps:
i) partially curing said at least one laminate and said at least one ink using at least one UV curing station such that an exposed, outer surface of said at least one ink cures to a hardness of approximately 15-20 Barcol degrees and forms a skin that allows it to be handled, while leaving an inner, unexposed portion of the ink that is in contact with the laminate sufficiently sticky and humid so as to allow sufficient time for the ink to chemically crosslink with the laminate during said second curing step; and
ii) subsequently allowing said at least one laminate and said at least one ink to fully cure in an area removed from said at least one UV curing station, said subsequent curing step allowing cross-linking to occur between the resin of the laminate and the resin of the at least one ink, thereby fusing the laminate and the at least one ink to form a unitary body.

2. The process of claim 1, wherein said at least one laminate is moved through several of the steps of the process on a conveyer belt, with said at least one laminate being moved by said belt past said at least one serigraphic device and through said at least one UV curing station, and wherein said curing step ii) occurs after said at least one printed laminate (panel) has moved off of said conveyer belt.

3. The process of claim 1, wherein said step of providing at least one ink comprises providing at least one ink comprising unsaturated polyester resin, with each of said at least one ink being pigmented in a respective desired color, and containing UV surface-curing photoinitiators, UV through-curing photoinitiators, chemical-thermal curing agent, and an inhibitor/drying-retarder system.

4. The process of claim 1, wherein said steps of providing at least one ink and at least one serigraphic device comprise providing a plurality of inks, each with a different color, and a plurality of serigraphic devices, with each serigraphic device applying a different one of said plurality of inks.

5. The process of claim 1, wherein said step of using at least one serigraphic device to apply said at least one ink onto at least one side of said at least one laminate comprises applying said at least one ink onto only a first side of said at least one laminate, and said step of providing at least one preexisting laminate comprises providing a laminate having a transparent, heat-sealable PET film (5) permanently incorporated onto a second side thereof.

6. The process of claim 1, comprising the additional step of laminating an additional layer of fiber reinforced polyester resin (FRP) on top of the at least one ink which was applied to the at least one laminate.

7. The process of claim 3, wherein said step of providing at least one ink comprises providing the UV photoinitiators in the form of a blend of at least two members of the group consisting of CIBA Irgacure 819, 369, 184, 907, and 651.

8. The process of claim 3, wherein said step of providing at least one ink containing a chemical-thermal curing agent comprises providing a catalyst in the form of methyl ethyl ketone peroxide and providing an accelerator in the form of one of the group consisting of cobalt naphtenate and cobalt octoate.

9. The process of claim 3, wherein said inhibitor/drying-retarder system is selected from the group consisting of tert-butyl-catechol, butyl-glycol, butyl-diglycol-ether, and butyl-triglycol-ether.

10. The process of claim 1, wherein said FRP laminate is formed by continuous lamination and cured by radiation on a base having a cylindrical form that creates a force which compresses the laminate against the base, which acts as a mold, assuring its perfect flatness and smoothness.

11. A silk-screened panel comprising a fiber reinforced unsaturated polyester resin laminate having a design silk-screened on at least one side thereof, said design formed by at least one ink, each of said at least one ink comprising unsaturated polyester resin mixed with a pigment in a respective desired color, a UV surface-curing photoinitiator, a UV through-curing photoinitiator, a chemical-thermal curing agent and an inhibitor/drying-retarder agent, with said panel manufactured by the steps of applying said at least one ink to at least one side of said laminate, and partially curing said laminate and said at least one ink using UV curing until an exposed, outer surface of said at least one ink cures to a hardness of approximately 15-20 Barcol degrees while an unexposed, inner portion of said at least one ink remains sticky and humid, whereupon said UV curing is stopped and the full curing of said panel and said at least one ink occurs slowly, during which the resin of said inner portion of said at least one ink chemically cross-links with the resin of said laminate, thereby fusing the laminate and the at least one ink to form a unitary body.

12. The silk-screened panel of claim 11, wherein said at least one ink comprises a plurality of inks, each with a different color.

13. The silk-screened panel of claim 11, wherein said design is present on only a first side of said laminate and a second side of said laminate has a transparent, heat-sealable PET film permanently incorporated thereon.

14. The silk-screened panel of claim 11, further comprising an additional layer of fiber reinforced polyester resin (FRP) laminated on top of the design.

15. The silk-screened panel of claim 11, wherein said at least one ink comprises UV photoinitiators in the form of a blend of at least two members of the group consisting of CIBA Irgacure 819, 369, 184, 907, and 651.

16. The silk-screened panel of claim 11, wherein said chemical-thermal curing agent comprises a composition of a catalyst comprising methyl ethyl ketone peroxide and an accelerator comprising one of the group consisting of cobalt naphtenate and cobalt octoate.

17. The silk-screened panel of claim 11, wherein said inhibitor/drying retarder agent is selected from the group consisting of tert-butyl-catechol, butyl glycol, butyl-diglycol-ether, and butyl-triglycol-ether.
